(19) United States
(12) Patent Application Publication
(10) Pub. No.: US 2014/0108832 A1
(43) Pub. Date: Apr. 17, 2014

(54) INFORMATION PROCESSING APPARATUS AND OPERATION CONTROL METHOD

(71) Applicant: KABUSHIKI KAISHA TOSHIBA, Tokyo (JP)

(72) Inventor: Akifumi Yamaguchi, Kunitachi-shi (JP)

(21) Appl. No.: 13/929,031

(22) Filed: Jun. 27, 2013

(30) Foreign Application Priority Data
Oct. 12, 2012 (JP) 2012-226881

(51) Int. Cl. G06F 1/20; G06F 1/32

(52) U.S. Cl. CPC G06F 1/203; G06F 1/3234
USPC 713/320

(57) ABSTRACT

According to one embodiment, an information processing apparatus includes a base unit including an upper including a keyboard, a display unit, a processor, a cooling fan, and a controller. The display unit is set at one of a first position where a display surface of the display unit and the upper surface are exposed and a second position where the display surface of the display unit is exposed and a rear surface of the display unit covers the upper surface. The controller lowers a rotational speed of the cooling fan and performance of the processor in response to a change in a setting position of the display unit from the first position to the second position.

### CROSS-REFERENCE TO RELATED APPLICATIONS

This application is based upon and claims the benefit of priority from Japanese Patent Application No. 2012-226881, filed Oct. 12, 2012, the entire contents of which are incorporated herein by reference.

### FIELD

Embodiments described herein relate generally to an information processing apparatus and an operation control method applied to the apparatus.

### BACKGROUND

In recent years, various portable personal computers of laptop type or notebook type have been developed. This type of computer uses a cooling method of cooling a heating device such as a CPU using a cooling fan.

In recent years, there have been a variety of personal computers, and a convertible computer, which can take a form corresponding to a notebook type personal computer, and a tablet computer has also been developed. The convertible computer can change its style between two styles (modes), that is, between a notebook mode and a tablet mode.

Usually, the convertible computer in the notebook mode is used on a desk, while the convertible computer in the tablet mode is used while being held by a hand or hands of the user. For example, the user holds the convertible computer of the tablet mode in one of his hands, and operates it using the other hand. The distance between the face of the user and the computer tends to be shorter in the tablet mode than in the notebook mode. In the tablet mode, therefore, the sound (noise) generated when the cooling fan is rotating may be offensive to the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing outer appearances respectively corresponding to the notebook mode and tablet mode of an information processing apparatus according to an embodiment.

FIG. 2 is an exemplary view for explaining the relationship between a base unit and a display unit which are provided in the information processing apparatus according to the embodiment.

FIG. 3 is an exemplary view showing the arrangement of a cooling fan and its surrounding components, which are provided in the information processing apparatus according to the embodiment.

FIG. 4 is an exemplary view for explaining a process in which the style of the information processing apparatus of the embodiment transits from the notebook mode to the tablet mode.

FIG. 5 is an exemplary block diagram showing a system configuration of the information processing apparatus according to the embodiment.

FIG. 6 is an exemplary table showing examples of a fan rotational speed and CPU performance corresponding to each mode of the information processing apparatus according to the embodiment.

FIG. 7 is an exemplary timing chart for explaining switching operations for the CPU performance and fan performance, which are performed in switching the information processing apparatus of the embodiment from the notebook mode to the tablet mode.

FIG. 8 is an exemplary flowchart illustrating the procedure of processing of changing the CPU performance and fan performance, which is executed by the information processing apparatus according to the embodiment.

FIG. 9 is an exemplary view for explaining another example of the relationship between the base unit and the display unit which are provided in the information processing apparatus according to the embodiment.

FIG. 10 is an exemplary perspective view showing an outer appearance when the display panel of the information processing apparatus of the embodiment is open, and that when the display panel is closed.

### DETAILED DESCRIPTION

Various embodiments will be described hereinafter with reference to the accompanying drawings.

In general, according to one embodiment, an information processing apparatus includes a base unit including an upper surface including a keyboard, a display unit, a processor, a cooling fan, and a controller. The display unit is set at one of a first position where a display surface of the display unit and the upper surface are exposed and a second position where the display surface of the display unit is exposed and a rear surface of the display unit covers the upper surface. The controller lowers a rotational speed of the cooling fan and performance of the processor in response to a change in a setting position of the display unit from the first position to the second position.

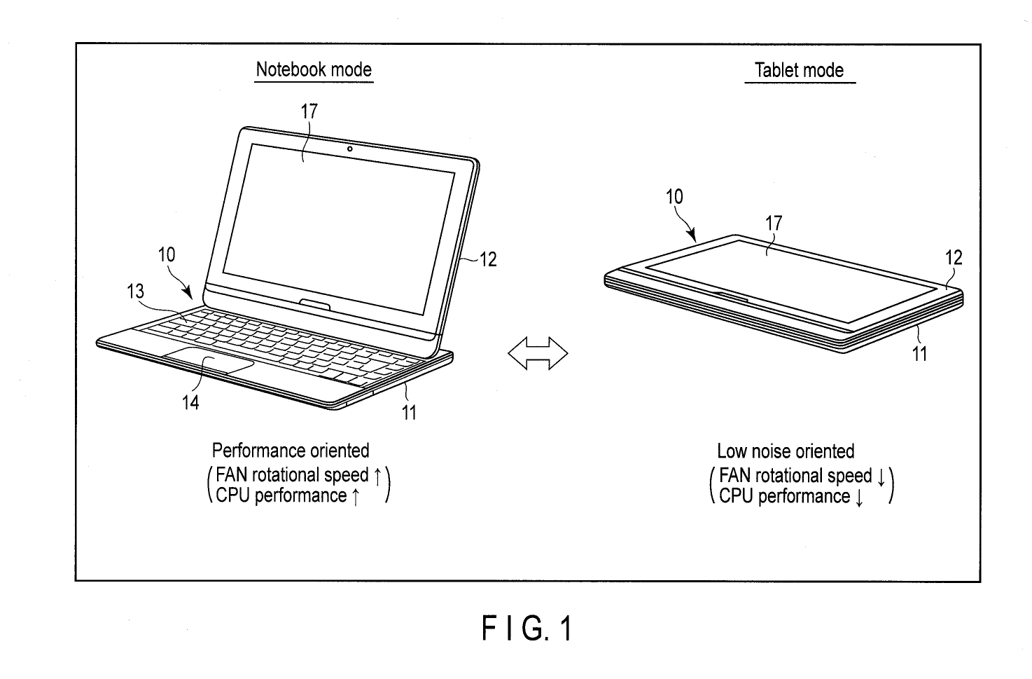

FIG. 1 shows outer appearances respectively corresponding to the notebook mode and tablet mode of an information processing apparatus according to the embodiment. The information processing apparatus is implemented as, for example, a convertible computer 10. The convertible computer 10 is used in a style corresponding to the notebook mode shown on the left side of FIG. 1 or the tablet mode shown on the right side of FIG. 1.

The convertible computer 10 includes a base unit 11 and a display unit 12. The base unit 11 includes a thin rectangular housing accommodating a CPU, a memory, other various electronic components, and the like. A keyboard 13 and a touchpad 14 serving as a pointing device are arranged on the upper surface of the base unit 11. The touchpad 14 is arranged in the palm rest region of the upper surface of the base unit 11.

A display 17 is arranged on the front surface of the display unit 12, that is, the display surface of the display unit 12. This display 17 is implemented by a touch screen display capable of detecting the position of a pen or finger on its screen.

The display unit 12 is set at a first position corresponding to the style of the notebook mode shown on the left side of FIG. 1 or a second position corresponding to the style of the tablet mode shown on the right side of FIG. 1. More specifically, the display unit 12 is set at the above-described first position (notebook mode) where the display surface of the display unit 12 and the upper surface of the base unit 11 are exposed or the above-described second position (tablet mode) where the display surface of the display unit 12 is exposed and the rear surface of the display unit 12 covers the upper surface of the base unit 11.

In the notebook mode, the convertible computer 10 is mainly used in a state in which it is placed on a horizontal surface like the surface of a desk. The user mainly operates the keyboard 13, similarly to a general notebook computer. In the notebook mode, the convertible computer 10 is required to operate without any problem even under high load, similarly to a general notebook computer.

In the embodiment, therefore, in the notebook mode, the computer 10 is cooled using a cooling method (performance oriented cooling method) which prioritizes the performance of the computer 10 over low noise as much as possible. In the performance oriented cooling method, the rotational speed [rpm] of the cooling fan within the base unit 11 is increased as the temperature of the CPU within the base unit 11 rises, thereby cooling the computer 10 (radiating the heat). The rotational speed of the cooling fan is predetermined for each CPU temperature range. The cooling fan is rotated at a rotational speed corresponding to a CPU temperature range within which the current CPU temperature falls. Basically, the CPU performance (CPU operation speed) can be continuously maintained at highest level (highest speed) irrespective of the current CPU temperature. As described above, in the performance oriented cooling method, processing of increasing the rotational speed of the cooling fan is preferentially executed over processing of lowering the CPU performance.

In the performance oriented cooling method, rotation of the cooling fan causes noise and increases the power consumption but the CPU performance is maintained at high level, thereby enabling to make full use of the performance of the computer 10.

On the other hand, in the tablet mode, the convertible computer 10 is mainly used while being held by the user with his/her hand or hands. The user, for example, holds the convertible computer 10 in his/her arm, and touches and operates the display 17 with the other hand. In the tablet mode, as described above, the distance between the user's face and the convertible computer 10 tends to be shorter than that in the notebook mode. If, therefore, the above-described performance oriented cooling method is used in the tablet mode, noise generated by the cooling fan may offend the user's ears. Furthermore, similarly to a general tablet computer, in the tablet mode, the convertible computer 10 is often used only under relatively low load.

In the embodiment, therefore, in the tablet mode, a cooling operation which prioritizes low noise over the performance is executed (a low noise oriented cooling method). In the low noise oriented cooling method, the fan rotational speed is set to a value smaller than that in the performance oriented cooling method. Furthermore, the CPU performance is set to a value lower than that in the performance oriented cooling method. Operating the computer 10 at low CPU performance can prevent the temperature of the computer 10 from excessively rising even if a low fan rotational speed is used.

In the low noise oriented cooling method, the rotational speed of the cooling fan may be predetermined for each CPU temperature range. In this case, the cooling fan rotational speed corresponding to each CPU temperature range need only be set to a value smaller than that corresponding to each CPU temperature range used in the performance oriented cooling method.

In this embodiment, in switching from the notebook mode to the tablet mode, processing of switching the cooling method of the computer 10 from the performance oriented cooling method to the low noise oriented cooling method, that is, processing of decreasing the fan rotational speed and CPU performance to be lower than those currently used in the notebook mode (performance oriented cooling method) is automatically executed.

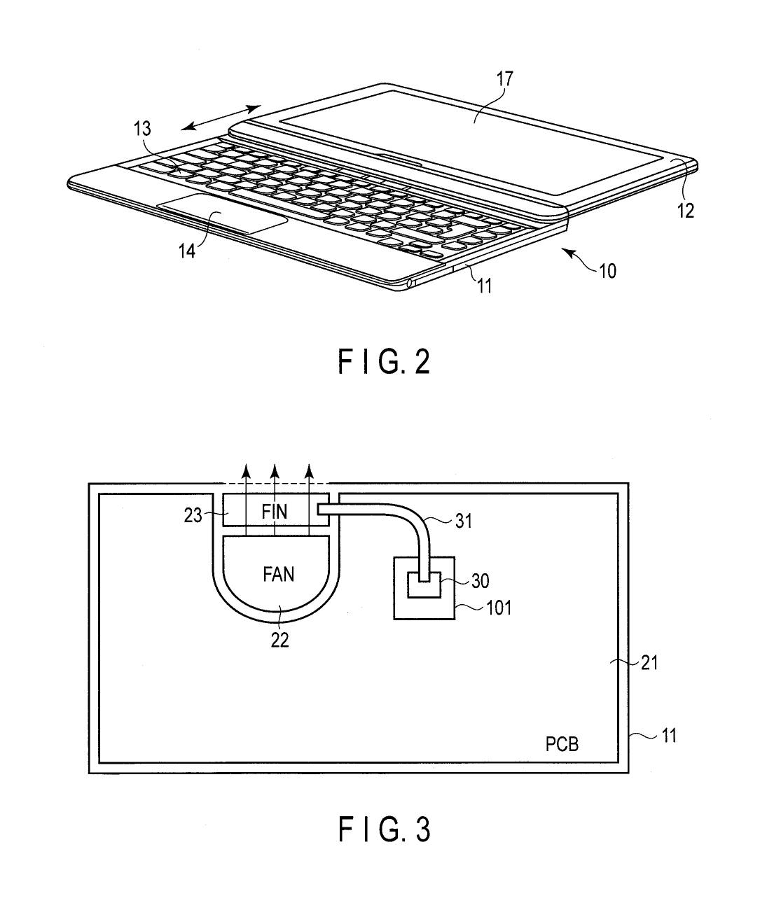

FIG. 2 shows an example of the relationship between the base unit 11 and the display unit 12. The display unit 12 is attached to a supporting member (hinge) arranged at the rear end portion of the base unit 11 so that the display surface of the display unit 12 is almost parallel to the upper surface of the base unit 11, that is, so that the display unit 12 is opened at about 180°. Furthermore, the display unit 12 is attached to the base unit 11 to be movable (slidable) between the front end portion and rear end portion of the base unit 11.

As a mechanism of sliding the display unit 12, various mechanisms can be used. For example, a guide rail (groove) may be provided on the rear surface of the display unit 12 to extend from the lower end portion to the upper end portion of the display unit 12. Furthermore, the supporting member (hinge) at the rear end portion of the base unit 11 may be slidably engaged with the guide rail. This arrangement makes it possible to slide the display unit 12 between the front end portion and rear end portion of the base unit 11 along the guide rail on the rear surface of the display unit 12 when the display unit 12 is open at about 180°.

In the state shown in FIG. 2, it is possible to set the computer 10 to the tablet mode by sliding the display unit 12 toward the front end portion of the base unit 11 so that the lower end portion of the display unit 12 reaches the front end portion of the base unit 11. Furthermore, in the state shown in FIG. 2, it is possible to set the computer 10 to the notebook mode by raising the upper end portion of the display unit 12.

FIG. 3 shows an arrangement around a cooling fan 22 within the base unit 11. As shown in FIG. 3, the base unit 11 includes a printed circuit board (PCB) 21, the cooling fan 22, a radiation fin 23, and a CPU 101. The printed circuit board (PCB) 21 is a so-called motherboard on which various electronic components constituting the computer 10 are mounted. The CPU 101 is arranged on the printed circuit board (PCB) 21.

A heat-receiving portion 30 is arranged on the CPU 101. The heat-receiving portion 30 and the radiation fin (heat sink) 23 are thermally connected by a heat pipe 31. The cooling fan 22 cools (air-cools) the radiation fin 23 in order to decrease the temperature of the CPU 101 and that within the base unit 11. In this case, the cooling fan 22 externally draws air through, for example, several openings (cooling vents) provided on the bottom surface of the base unit 11, and the air cools the radiation fin 23. When the radiation fin 23 is cooled, the temperature of the CPU 101 decreases, and then the temperature within the base unit 11 also decreases. The air within the base unit 11 is externally discharged through, for example, openings (cooling vents) provided on the rear surface of the base unit 11.

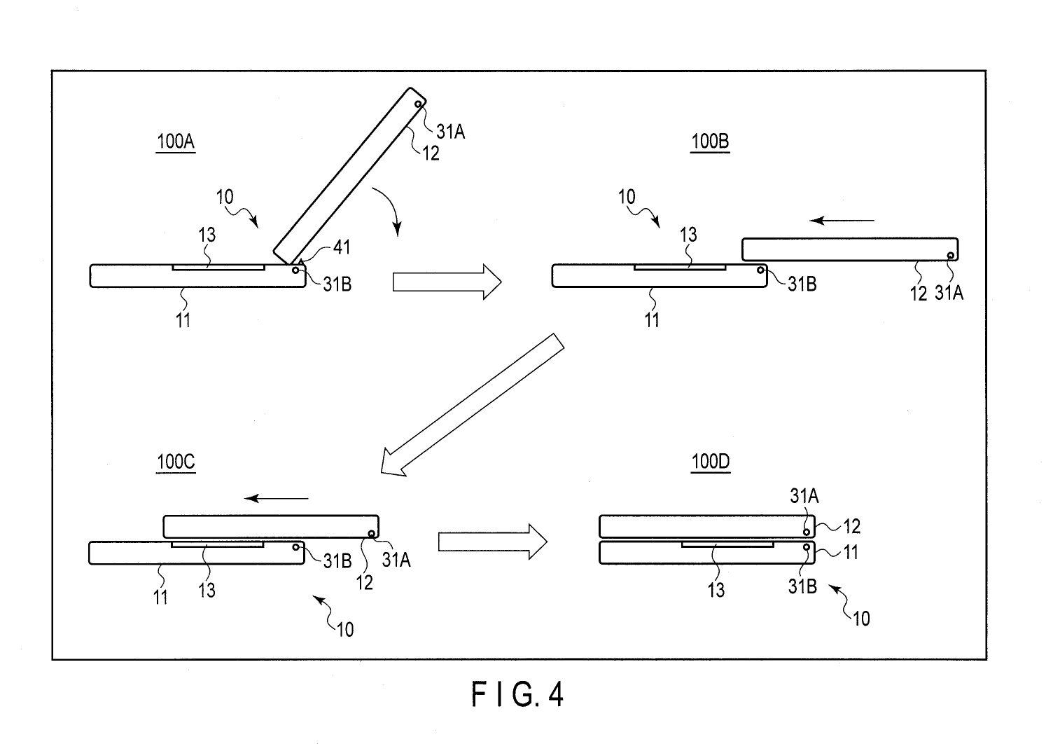

FIG. 4 shows a process in which the style of the computer 10 transits from the notebook mode to the tablet mode. Referring to FIG. 4, a state 100A indicates the above-described notebook mode. In a state 100B, the display unit 12 of the convertible computer 10 in the notebook mode is open at about 180°. In a state 100C, part (the palm rest region) of the upper surface of the base unit 11 is exposed and the rear surface of the display unit 12 covers the other part of the upper surface by sliding the display unit 12 which is open at about 180° toward the front end portion of the base unit 11. A state 100D indicates the above-described tablet mode.

In the state 100A, the computer 10 can be transited to the state 100B by opening the display unit 12 at about 180°. In the state 100B, the computer 10 can be transited to the state 100C by sliding the display unit 12 toward the front end portion of the base unit 11. In the state 100C, the computer 10 can be transited to the state 100D by further sliding the display unit 12 toward the front end portion of the base unit 11.

In the state 100D, the computer 10 can be transited to the state 100C by sliding the display unit 12 toward the rear end portion of the base unit 11. In the state 100C, the computer 10 can be transited to the state 100B by further sliding the display unit 12 toward the rear end portion of the base unit 11. In the state 100B, the computer 10 can be transited to the state 100A by raising the upper end portion of the display unit 12.

Switching between the notebook mode and the tablet mode can be detected using a display panel opening/closing sensor. The display panel opening/closing sensor functions as a sensor configured to detect a change in the setting position of the display unit 12 from the above-described first position to the above-described second position.

As the display panel opening/closing sensor, a hardware switch 41 arranged in the rear end portion of the upper surface of the base unit 11 and/or a Hall element (magnetic sensor) 31B provided within the base unit 11, which faces the rear end portion of the upper surface of the base unit 11, can be used. A magnet (magnetic material) 31A is arranged in the upper end portion of the rear surface of the display unit 12. The Hall element (magnetic sensor) 31B can detect whether the magnet (magnetic material) 31A is close to the Hall element (magnetic sensor) 31B, that is, whether the computer 10 is in the tablet mode (state 100D). The hardware switch 41 can detect whether the computer 10 is in the notebook mode (state 100A).

Note that the current style of the computer 10 may be determined using only the hardware switch 41. In this case, transition from the state 100A to the state 100B may be detected as switching from the notebook mode to the tablet mode. Furthermore, transition from the state 100B to the state 100A may be detected as switching from the tablet mode to the notebook mode.

The current style of the computer 10 may be determined using only the detection output of the Hall element 31B. In this case, transition from the state 100C to the state 100D may be detected as switching from the notebook mode to the tablet mode. Furthermore, transition from the state 100D to the state 100C may be detected as switching from the tablet mode to the notebook mode.

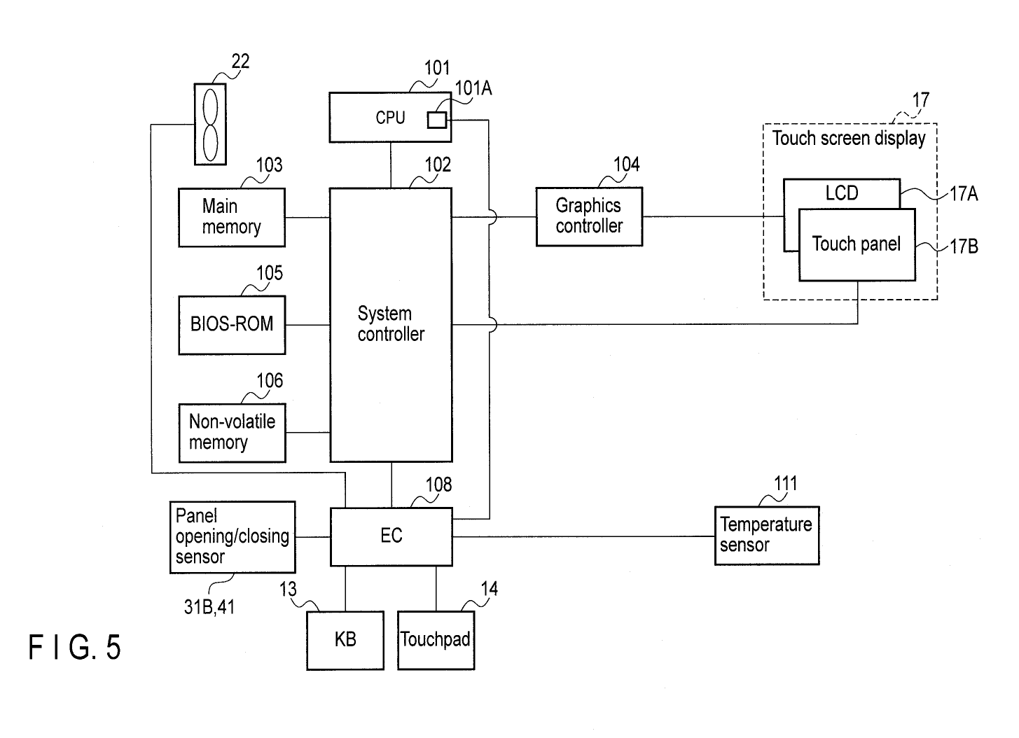

FIG. 5 shows the system configuration of the computer 10.

In addition to the above-described keyboard 13, touchpad 14, and CPU 101, the computer 10 includes a system controller 102, a main memory 103, a graphics controller 104, a BIOS-ROM 105, a non-volatile memory 106, and an embedded controller (EC) 108.

The CPU 101 serves as a processor configured to control the operation of each component of the computer 10. The CPU 101 executes various software programs loaded from the non-volatile memory 106 into the main memory 103. The software programs include an operating system (OS) and various application programs. The CPU 101 also executes the basic input/output system (BIOS) stored in the BIOS-ROM 105. The BIOS is a program for hardware control. The BIOS can include a routine for selectively using the above-described performance oriented cooling method or low noise oriented cooling method to execute cooling control processing. Instead of the BIOS, a firmware program as a program executed by the embedded controller (EC) 108 may execute the procedure of the cooling control processing.

The system controller 102 is connected to the local bus of the CPU 101. The system controller 102 incorporates a memory controller for making access control of the main memory 103. The system controller 102 also has a function of communicating with the graphics controller 104 via a serial bus complying with, for example, the PCI EXPRESS standard.

The graphics controller 104 is a display controller for controlling an LCD 17A used as a display monitor of the computer 10. A display signal generated by the graphics controller 104 is sent to the LCD 17. The LCD 17A displays images based on the display signal. A touch panel 17B is arranged on the LCD 17A. The touch panel 17B is configured to detect the position of a pen or finger on the screen of the LCD 17A. The user can use the touch panel 17B to operate a graphical user interface (GUI) and the like displayed on the screen of the LCD 17A. For example, the user can touch a button displayed on the screen to instruct execution of a function corresponding to the button. Note that a digitizer may be arranged on the LCD 17A, instead of or in addition to the touch panel 17B.

The system controller 102 incorporates an ATA controller for controlling the non-volatile memory 106. The non-volatile memory 106 is implemented by a semiconductor storage device such as an SSD.

The EC 108 is a one-chip microcomputer including an embedded controller for power management. The EC 108 has a function of turning on/off the computer 10 according to a user operation for a power button. The EC 108 includes a keyboard controller configured to control the keyboard 13 and the touchpad 14.

The EC 108 is connected to the above-described display panel opening/closing sensor (hardware switch 41 or Hall element 31B) and the cooling fan 22. By acquiring the detection output of the above-described display panel opening/closing sensor via a control register within the EC 108, the BIOS can detect a change in the setting position of the display unit 12 from the above-described first position to the above-described second position, that is, a change from the notebook mode to the tablet mode, and also detect a change in the setting position of the display unit 12 from the above-described second position to the above-described first position, that is, a change from the tablet mode to the notebook mode.

Furthermore, the BIOS can change the rotational speed of the cooling fan 22 by setting a parameter indicating the rotational speed of the cooling fan 22 in another control register within the EC 108. The BIOS can acquire the temperature of the CPU 101 through still another control register within the EC 108. For example, a temperature sensor 101A within the CPU 101 may detect the temperature of the CPU 101.

Moreover, the BIOS can acquire, through still another control register within the EC 108, a detected value of a temperature sensor 111 arranged on the printed circuit board 21. The detected value of the temperature sensor 111 is used to estimate the surface temperature (housing surface temperature) of the base unit 11.

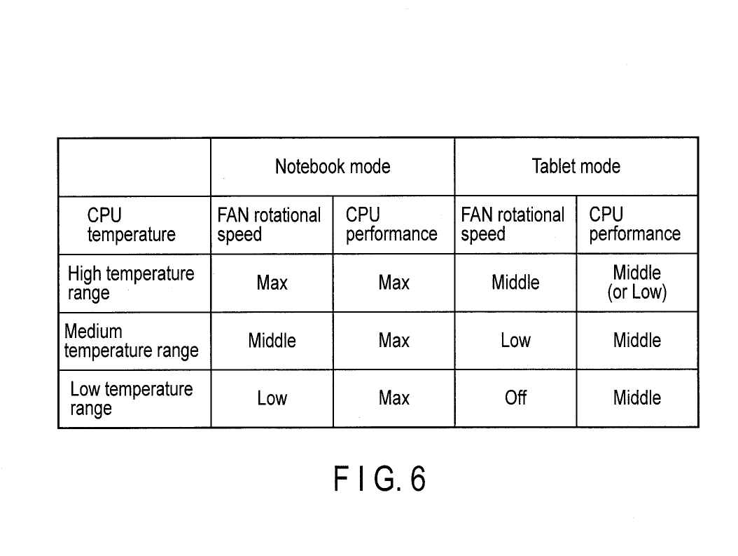

FIG. 6 shows examples of a fan rotational speed and CPU performance used in each temperature range in the notebook mode, and those in the tablet mode.

In this embodiment, in either the notebook mode or the tablet mode, a fan rotational speed and CPU performance corresponding to each of a plurality of temperature ranges are defined. In this example, for the sake of simplicity, a range for the CPU temperature is divided into three temperature ranges: a low temperature range, medium temperature range, and high temperature range.

In the notebook mode, to prioritize the performance over low noise, the CPU performance corresponding to each of the low temperature range, medium temperature range, and high temperature range is maximum performance “Max”. On the other hand, the fan rotational speed increases as the CPU temperature rises. The fan rotational speed corresponding to the low temperature range is a low speed “Low”, the fan rotational speed corresponding to the medium temperature range is a middle speed “Middle”, and the fan rotational speed corresponding to the high temperature range is a maximum speed “Max”.

In the tablet mode, to prioritize low noise over the performance, a fan rotational speed lower than that in the notebook mode is used in the respective CPU temperature ranges. For example, in the low temperature range, the fan rotational speed is “Off”, that is, the cooling fan 22 is not rotated. The fan rotational speed corresponding to the medium temperature range is a low speed “Low”, and the fan rotational speed corresponding to the high temperature range is a middle speed “Middle”. Furthermore, in the tablet mode, CPU performance lower than that in the notebook mode is used in the respective CPU temperature ranges. For example, the CPU performance corresponding to each of the low temperature range, medium temperature range, and high temperature range is middle performance “Middle”. Note that the CPU performance corresponding to the high temperature range may be set to low performance “Low”.

In the tablet mode, the CPU performance may be lowered step by step as the CPU temperature rises. If, for example, the CPU performance can be switched among four steps of maximum performance “Max”, high performance “High”, middle performance “Middle”, and low performance “Low”, the CPU performance corresponding to the low temperature range may be set to high performance “High”, the CPU performance corresponding to the medium temperature range may be set to middle performance “Middle”, and the CPU performance corresponding to the high temperature range may be set to low performance “Low”.

It is possible to change the CPU performance by, for example, dynamically changing the frequency of a clock signal supplied to the CPU 101. Alternatively, the CPU performance may be changed using throttling control for intermittently operating the CPU 101. In this case, it is possible to change the CPU performance by changing the ratio of a CPU operation time to a throttling cycle. As the ratio of the CPU operation time to the throttling cycle increases, the CPU performance can also be increased.

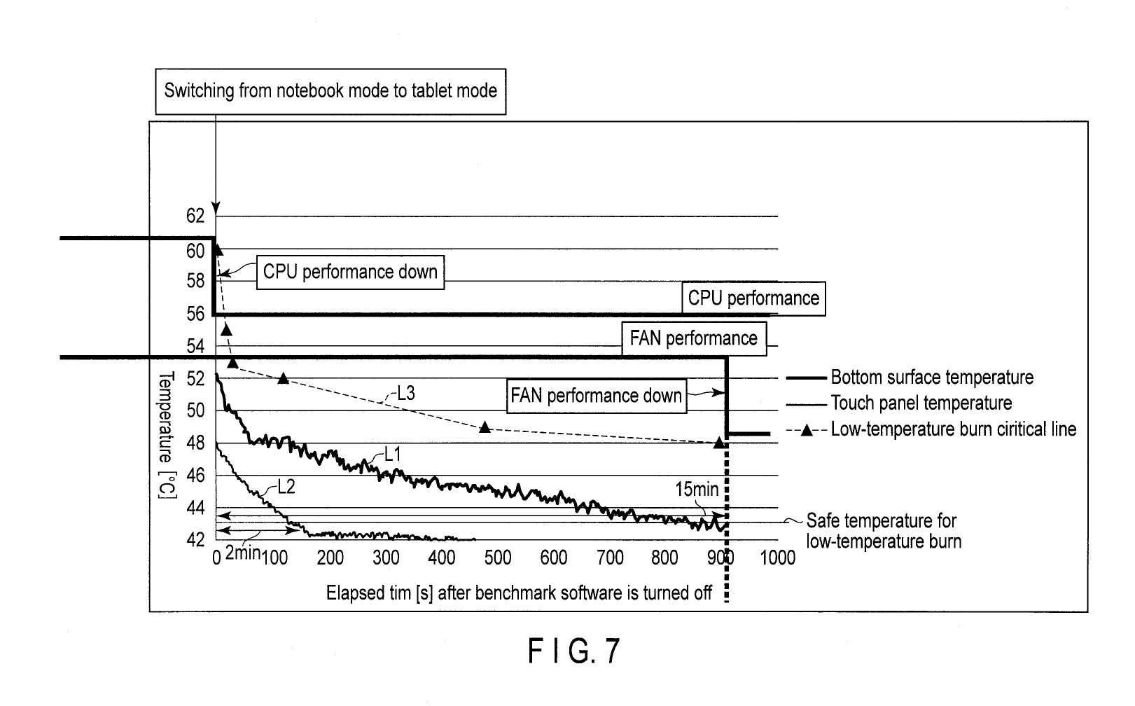

FIG. 7 shows switching operations for the CPU performance and fan performance which are performed in switching from the notebook mode to the tablet mode.

As described above, in this embodiment, the performance oriented cooling method for cooling the computer 10 by increasing the fan rotational speed is used in the notebook mode. On the other hand, the low noise oriented cooling method for cooling the computer 10 by decreasing the fan rotational speed as compared with the notebook mode, and using CPU performance lower than that in the notebook mode is used to prioritize low noise over the performance in the tablet mode. In this embodiment, therefore, in response to switching from the notebook mode to the tablet mode, the fan rotational speed and CPU performance are automatically lowered, thereby enabling to switch to the low noise oriented cooling method suitable for the tablet mode in which the user often holds the computer 10 with his/her hand to use it.

Note that in switching from the notebook mode to the tablet mode, it is not always necessary to simultaneously lower both the fan rotational speed and the CPU performance. In this embodiment, in response to a change from the notebook mode to the tablet mode, operation control can be executed in which the processor performance is lowered first, and then the fan rotational speed is decreased after the surface temperature (housing surface temperature) of the base unit 11 decreases to a reference temperature. With this control, the fan rotational speed is not decreased when the surface temperature of the base unit 11 is relatively high, thereby maintaining the fan rotational speed at that used in the notebook mode immediately before the switching. Unlike a case in which the fan rotational speed is unconditionally decreased in response to switching from the notebook mode to the tablet mode, it is possible to make full use of the cooling performance after switching from the notebook mode to the tablet mode, thereby enabling to prevent the occurrence of a problem such as a low-temperature burn.

FIG. 7 shows a change in the surface temperature of the base unit 11 and that in the surface temperature (touch panel temperature) of the display 17 when the above-described operation control is executed in switching from the notebook mode to the tablet mode. Referring to FIG. 7, reference symbol L1 (a thick solid line) denotes a change in the surface temperature of the base unit 11 (the bottom surface temperature of the base unit 11 in this example); and L2 (a thin solid line) denotes a change in the surface temperature of the display 17 (the temperature of the touch panel in this example).

Assume that a high load is imposed on the computer 10 in the notebook mode, and a medium load is imposed on the computer 10 in the tablet mode. To re-create the situation, benchmark software is executed in the notebook mode, and the benchmark software is stopped in switching from the notebook mode to the tablet mode.

As is apparent from FIG. 7, immediately after switching from the notebook mode as a high-load state to the tablet mode, the BIOS lowers not the fan rotational speed (fan performance) but the CPU performance. The fan rotational speed is maintained at that used in the notebook mode immediately before the switching. The temperature of the bottom surface of the base unit 11 is higher than that of the touch panel. In the tablet mode, for example, the user may operate the computer 10 while holding the bottom surface of the base unit 11 in his/her arm. In this embodiment, therefore, to increase the level of safety of the computer 10, processing of decreasing the fan rotational speed is executed after confirming that the bottom surface temperature is sufficiently low.

Referring to FIG. 7, a broken line L3 represents a low-temperature burn critical line. A region above the low-temperature burn critical line (broken line L3) indicates a zone where the user may suffer a low-temperature burn. This zone is defined based on the surface temperature of a given object and a time (touch time) during which a body touches the object. An elapsed time after switching from the notebook mode to the tablet mode, that is, after the benchmark software is stopped (turned off) is set as the above-described touch time. As indicated by the broken line L3, for example, if the surface temperature is 52° C. and the touch time is equal to or longer than 100 sec, the user may suffer a low-temperature burn.

In this embodiment, if the style of the computer 10 with a relatively high bottom surface temperature is switched from the notebook mode to the tablet mode, the rotational speed of the cooling fan 22 is not decreased, and the cooling fan 22 continues to rotate at the fan rational speed used in the notebook mode immediately before the switching. Maintaining the rotational speed of the cooling fan 22 and lowering the CPU performance can efficiently decrease the bottom surface temperature, thereby enabling to maintain the bottom surface temperature at a value sufficiently smaller than that indicated by the low-temperature burn critical line.

After the bottom surface temperature decreases to a reference temperature (a safe temperature for a low-temperature burn), the BIOS decreases the fan rotational speed. As described above, by decreasing the fan rotational speed after confirming that the bottom surface temperature has decreased to the safe temperature, it is possible to ensure a high level of safety.

Based on a temperature detected by the above-described temperature sensor 111 on the printed circuit board 21 within the base unit 11, the BIOS can determine whether the surface temperature (bottom temperature in this example) of the base unit 11 is equal to or lower than the reference temperature. Since there is a correlation between the bottom surface temperature and the temperature at the position on the printed circuit board 21 where the temperature sensor 111 is arranged, the BIOS can determine whether the surface temperature of the base unit 11 is equal to or lower than the reference temperature, based on the temperature detected by the temperature sensor 111 and the correlation between the bottom surface temperature and the temperature on the printed circuit board 21.

Alternatively, the BIOS may stand by until a given reference time elapses after switching from the notebook mode to the tablet mode. After the reference time elapses, the BIOS may then decrease the fan rotational speed.

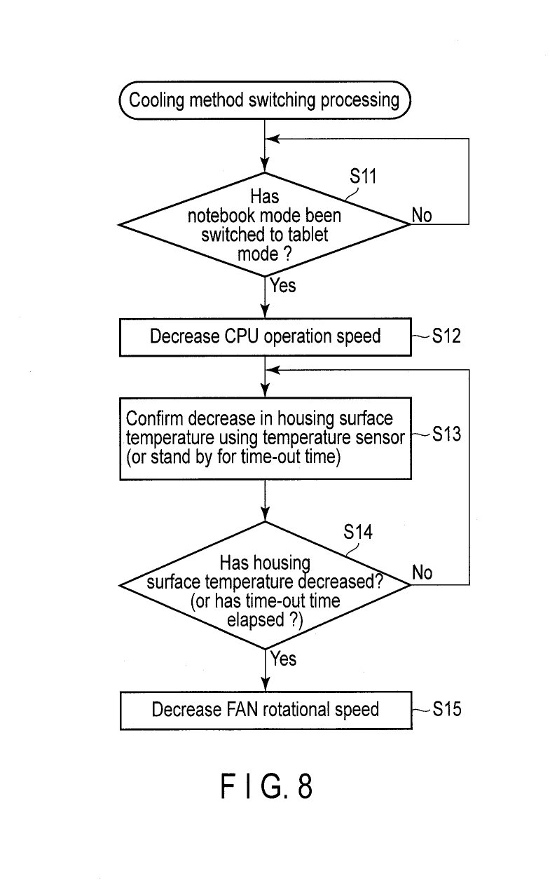

The procedure of operation control processing of switching the cooling method according to the embodiment will be described with reference to a flowchart shown in FIG. 8. Assume that the BIOS executes the operation control processing.

The BIOS detects switching from the notebook mode to the tablet mode, that is, a change in the setting position of the display unit 12 from the first position to the second position, using the detection output of the above-described display opening/closing sensor (step S11). If switching from the notebook mode to the tablet mode is detected (YES in step S11), the BIOS executes processing of switching from the performance oriented cooling method in which the rotational speed of the cooling fan 22 is increased as the temperature of the CPU 101 rises to prioritize the performance over low noise to the low noise oriented cooling method in which the rotational speed of the cooling fan 22 and the performance of the CPU 101 are respectively set to values lower than those used in the performance oriented cooling method to prioritize low noise over the performance.

In this case, the BIOS uses the above-described throttling control or the like to decrease the performance of the CPU 101 (CPU operation speed) to be lower than the current performance of the CPU 101 (current CPU operation speed) (step S12). If, for example, the current CPU temperature detected by the temperature sensor 101A within the CPU falls within the low temperature range or medium temperature range, the BIOS lowers the performance of the CPU 101 from the maximum performance “Max” (current CPU performance) to the middle performance “Middle”. Alternatively, if the current CPU temperature detected by the temperature sensor 101A within the CPU falls within the high temperature range, the BIOS lowers the performance of the CPU 101 from the maximum performance “Max” (current CPU performance) to the middle performance “Middle” or the low performance “Low”.

The BIOS uses the temperature sensor 111 to check the surface temperature (bottom surface temperature) of the base unit 11 (step S13). The BIOS then determines whether the surface temperature (bottom surface temperature) of the base unit 11 has decreased to the reference temperature, that is, whether the surface temperature (bottom surface temperature) of the base unit 11 is equal to or lower than the reference temperature (step S14).

If the surface temperature (bottom surface temperature) of the base unit 11 is equal to or lower than the reference temperature (YES in step S14), the BIOS decreases the rotational speed of the cooling fan 22 with respect to the current fan rotational speed (step S15). If, for example, the current CPU temperature detected by the temperature sensor 101A within the CPU falls within the low temperature range, the BIOS decreases the rotational speed of the cooling fan 22 from the low speed “Low” (the current fan rotational speed) to zero corresponding to “Off” indicating a stop state. If the current CPU temperature detected by the temperature sensor 101A within the CPU falls within the medium temperature range, the BIOS decreases the rotational speed of the cooling fan 22 from the middle speed “Middle” (the current fan rotational speed) to the low speed “Low”. Alternatively, if the current CPU temperature detected by the temperature sensor 101A within the CPU falls within the high temperature range, the BIOS decreases the rotational speed of the cooling fan 22 from the maximum speed “Max” (the current fan rotational speed) to the middle speed “Middle”.

On the other hand, if the surface temperature (bottom surface temperature) of the base unit 11 is higher than the reference temperature (NO in step S14), the BIOS maintains the current rotational speed of the cooling fan 22 without decreasing it. The BIOS stands by for the surface temperature (bottom surface temperature) of the base unit 11 to decrease to the reference temperature while repeating the processing in steps S13 and S14. If the surface temperature (bottom surface temperature) of the base unit 11 becomes equal to or lower than the reference temperature (YES in step S14), the BIOS decreases the rotational speed of the cooling fan 22 (step S15). In this case, as described above, for example, if the current CPU temperature detected by the temperature sensor 101A within the CPU falls within the low temperature range, the BIOS decreases the rotational speed of the cooling fan 22 from the low speed “Low” (the current fan rotational speed) to zero corresponding to “Off” indicating a stop state. If the current CPU temperature detected by the temperature sensor 101A within the CPU falls within the medium temperature range, the BIOS decreases the rotational speed of the cooling fan 22 from the middle speed “Middle” (the current fan rotational speed) to the low speed “Low”. Alternatively, if the current CPU temperature detected by the temperature sensor 101A within the CPU falls within the high temperature range, the BIOS decreases the rotational speed of the cooling fan 22 from the maximum speed “Max” (the current fan rotational speed) to the middle speed “Middle”.

In the above-described processing in steps S13 and S14, the BIOS determines based on the temperature detected by the temperature sensor 101A whether the surface temperature (bottom surface temperature) of the base unit 11 is equal to or lower than the reference temperature. Instead of this processing, however, the BIOS may determine whether a given reference time (time-out time) has elapsed after changing the mode. After the time-out time has elapsed, the BIOS may decrease the rotational speed of the cooling fan 22.

The above control operation can ensure low noise in the tablet mode and prevent the occurrence of a problem such as a low-temperature burn.

In the above description, the display unit 12 is attached to the base unit 11 to slide over it. However, a structure for connecting the display unit 12 and the base unit 11 is not limited to this.

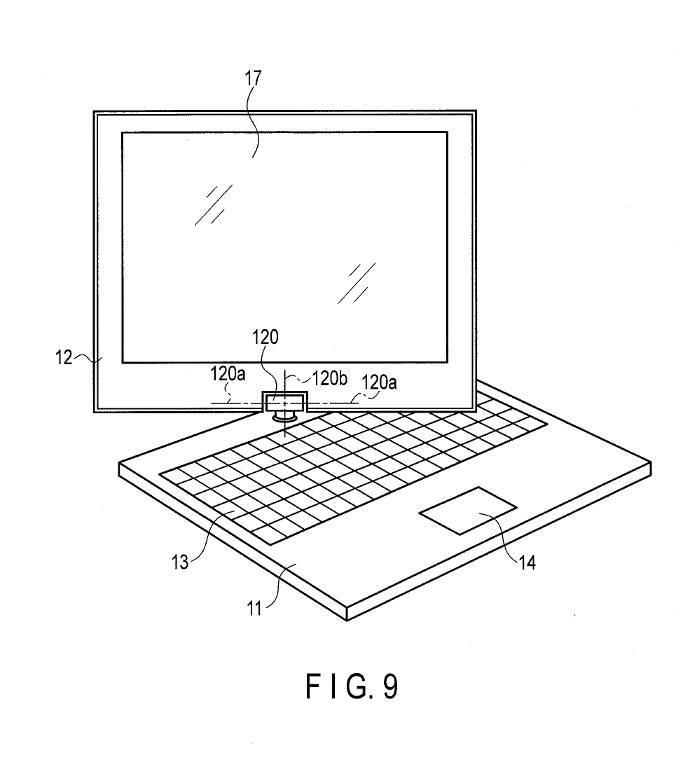

Referring to FIG. 9, for example, the display unit 12 is rotatably attached to the base unit 11 by a hinge portion 120. The hinge portion 120 has two axes, that is, a first axis 120a extending parallel to the upper surface of the base unit 11 and a second axis 120b extending in a direction perpendicular to the first axis 120a. The display unit 12 is attached to the base unit 11 to rotate about the first axis 120a. In other words, the display unit 12 can rotate about the first axis 120a between an open position where the upper surface of the base unit 11 is exposed and a closed position where the display surface of the display unit 12 covers the upper surface of the base unit 11.

Furthermore, the display unit 12 can also rotate about the second axis 120b by 180°. In other words, the display unit 12 can rotate about the second axis 120b between a first position where the display surface faces the front side of the computer 10 (the rotation angle of the display unit 12 is 0°) and a second position where the rear surface of the display unit 12 faces the front side of the computer 10 (the rotation angle of the display unit is 180°).

A state in which the display unit 12 rotates about the second axis 120b by 180° and the display unit 12 is closed, that is, a state in which the display unit 12 is set at a position where the rear surface of the display unit 12 covers the upper surface of the base unit 11 corresponds to the above-described tablet mode.

As described above, according to the embodiment, the rotational speed of the cooling fan 22 and the performance of the CPU 101 are lowered in response to a change in the setting position of the display unit 12 from the first position to the second position. It is, therefore, possible to readily change the control of the cooling fan without any user operation of changing the cooling method. In the tablet mode in which the convertible computer 10 is used with the user's face close to it, it is possible to use the cooling method which prioritizes low noise.

Furthermore, in this embodiment, the performance of the CPU 101 is lowered first in response to a change in the setting position of the display unit 12 from the first position to the second position. After the surface temperature of the base unit 11 decreases to the reference temperature, the rotational speed of the cooling fan 22 is decreased. This can increase the level of safety.

Note that a computer program can implement the procedure of the operation control processing according to this embodiment. It is, therefore, possible to readily obtain the same effects as those in this embodiment by only installing the computer program in a general convertible computer through a computer-readable storage medium storing the computer program, and executing it.

In the embodiment, a case in which the CPU performance and cooling fan performance are lowered in response to switching from the notebook mode to the tablet mode has been described. In a general notebook computer or a convertible computer with the structure shown in FIG. 9, it is possible to execute processing of lowering the CPU performance and cooling fan performance in response to switching from the notebook mode (the display panel is open) to a mode (the display panel is closed) in which the display surface and the keyboard 13 are not exposed.

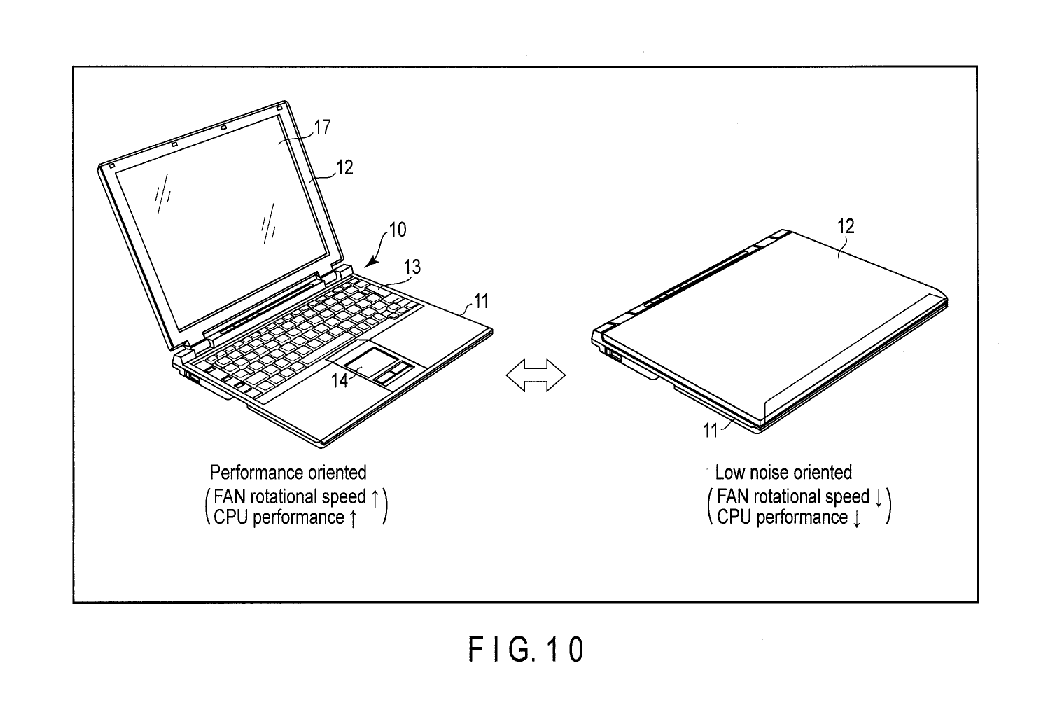

The computer 10 shown in FIG. 10 can operate in either the notebook mode (the display panel is open) shown on the left side of FIG. 10 or a mode (the display panel is closed) shown on the right side of FIG. 10.

In the computer 10 shown in FIG. 10, the display unit 12 is attached to the base unit 11 to be rotatable between an open position where the upper surface of the base unit 11 is exposed and a closed position where the display surface of the display unit 12 covers the upper surface of the base unit 11. The computer 10 can operate when the display unit 12 is set at either the open position or the closed position.

If, for example, the user moves to a meeting room, he/she may close the display unit 12 and carry the computer 10 with the display unit 12 closed. When the display unit 12 is closed, an actual operation such as a keyboard operation is not performed, and therefore no high CPU performance is required in many cases. It may be undesirable if the cooling fan continues to rotate at the same rotational speed as that in the notebook mode immediately before changing the mode although the user performs no operation.

To deal with this problem, the computer 10 shown in FIG. 10 executes processing of automatically lowering the CPU performance and cooling fan performance in response to switching from the notebook mode (the display panel is open) to the mode (the display panel is closed) in which the display surface and the keyboard 13 are not exposed, that is, in response to a change in the setting position of the display unit 12 from the above-described open position to the closed position. This automatically switches the cooling method from the above-described performance oriented cooling method to the above-described low noise oriented cooling method when the display unit 12 is closed. The computer 10 thus operates with the lower rotational speed of the cooling fan 22 and the lower performance of the CPU 101. It is, therefore, possible to ensure low noise and reduce the power consumption. When the display unit 12 is opened, the cooling method returns from the low noise oriented cooling method to the performance oriented cooling method.

Note that even when the display unit 12 is closed, the operation control processing described with reference to FIG. 8 is executed, thereby performing the control operation in which the fan rotational speed is not decreased before the surface temperature (bottom surface temperature) of the base unit 11 decreases to the reference temperature.

In addition to switching from the notebook mode to the tablet mode, the convertible computer with the structure shown in FIG. 9 can apply the control operation of automatically lowering the CPU performance and cooling fan performance even in switching from the notebook mode to the mode (the display panel is closed) in which the display surface and the keyboard 13 are not exposed.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a base unit comprising an upper surface comprising a keyboard;
a display unit configured to be set at one of a first position where a display surface of the display unit and the upper surface are configured to be exposed and a second position where the display surface of the display unit is configured to be exposed and a rear surface of the display unit is configured to cover the upper surface;
a processor;
a cooling fan; and
a controller configured to lower a rotational speed of the cooling fan and performance of the processor in response to a change in a setting position of the display unit from the first position to the second position.

2. The apparatus of claim 1, wherein the controller is further configured to lower the performance of the processor in response to the change in the setting position of the display unit from the first position to the second position, and lower the rotational speed of the cooling fan after a surface temperature of the base unit decreases to a reference temperature.

3. The apparatus of claim 2, wherein the controller is further configured to determine whether the surface temperature of the base unit is not higher than the reference temperature, based on a temperature detected by a temperature sensor on a printed circuit board within the base unit.

4. The apparatus of claim 2, wherein the surface temperature of the base unit is a temperature of a bottom surface of the base unit.

5. The apparatus of claim 4, wherein the controller is further configured to determine whether the surface temperature of the base unit is not higher than the reference temperature, based on a temperature detected by a temperature sensor on a printed circuit board within the base unit and a correlation between a temperature on the printed circuit board and the temperature of the bottom surface of the base unit.

6. The apparatus of claim 1, wherein the controller is further configured to lower the performance of the processor in response to the change in the setting position of the display unit from the first position to the second position, and lower the rotational speed of the cooling fan after a reference time elapses since the setting position is changed.

7. The apparatus of claim 1, wherein the controller is further configured to switch from a first cooling method to a second cooling method in response to the change in the setting position of the display unit from the first position to the second position,
wherein in the first cooling method, the rotational speed of the cooling fan is configured to be raised as a temperature of the processor rises to prioritize the performance over low noise, and
wherein in the second cooling method, the rotational speed of the cooling fan and the performance of the processor are respectively set to values smaller than those of the rotational speed of the cooling fan and the performance of the processor used in the first cooling method to prioritize low noise over the performance.

8. The apparatus of claim 1, further comprising
a sensor configured to detect the change in the setting position of the display unit from the first position to the second position.

9. An operation control method for an information processing apparatus, the apparatus comprising a base unit comprising an upper surface comprising a keyboard, and a display unit set at one of a first position where a display surface of the display unit and the upper surface are configured to be exposed and a second position where the display surface of the display unit is configured to be exposed and a rear surface of the display unit is configured to cover the upper surface, the method comprising:
detecting a change in a setting position of the display unit from the first position to the second position; and
lowering, in response to detection of the change in the setting position of the display unit, a rotational speed of a cooling fan within the base unit, and lowering performance of a processor within the base unit.

10. A computer-readable, non-transitory storage medium comprising a computer program configured to be executed by a computer, the computer comprising a base unit comprising an upper surface comprising a keyboard, and a display unit set at one of a first position where a display surface of the display unit and the upper surface are configured to be exposed and a second position where the display surface of the display unit is configured to be exposed and a rear surface of the display unit is configured to cover the upper surface, the computer program controlling the computer to execute functions of:
detecting a change in a setting position of the display unit from the first position to the second position, and
lowering, in response to detection of the change in the setting position of the display unit, a rotational speed of a cooling fan within the base unit, and lowering performance of a processor within the base unit.

11. An information processing apparatus comprising a base unit comprising an upper surface comprising a keyboard, and a display unit, the apparatus is configured to operate regardless of whether the display unit is set at a first position where a display surface of the display unit and the upper surface are exposed, or at a second position where the display surface of the display unit covers the upper surface, the apparatus comprising:
a processor;
a cooling fan; and
a controller configured to lower a rotational speed of the cooling fan and performance of the processor in response to a change in a setting position of the display unit from the first position to the second position.
